(19) United States
(12) Patent Application Publication
(10) Pub. No.: US 2007/0091026 A1
(43) Pub. Date: Apr. 26, 2007

(54) Plasma display device and driving method thereof

(76) Inventor: Sang-Shin Kwak, Yongin-si (KR)

Correspondence Address: CHRISTIE, PARKER & HALE, LLP, PO BOX 7068, PASADENA, CA, 91109-7068, US

(21) Appl. No.: 11/542,776

(22) Filed: Oct. 3, 2006

(30) Foreign Application Priority Data
Oct. 11, 2005 (KR) 10-2005-0095368
Nov. 2, 2005 (KR) 10-2005-0104203
Nov. 2, 2005 (KR) 10-2005-0104205

(51) Int. Cl. G09G 3/28

(52) U.S. Cl. 345/68

(57) ABSTRACT

In a plasma display device, a drain of a first transistor is coupled to a power source supplying a Vs/2 voltage, and a second transistor is coupled between a source of the first transistor and a ground terminal. A first terminal of a capacitor is coupled to a node of the first transistor and the second transistor, and a diode is coupled between the Vs/2 power source and a second terminal of the capacitor. A third transistor is coupled between the second terminal of the capacitor and a plurality of first electrodes, and a fourth transistor is coupled between the plurality of first electrodes and the first terminal of the capacitor.

### CROSS-REFERENCE TO RELATED APPLICATION

This application claims priority to and the benefit of Korean Patent Application No. 10-2005-0095368, filed on Oct. 11, 2005, Korean Patent Application No. 10-2005-0104203, filed on Nov. 02, 2005, and Korean Patent Application No. 10-2005-0104205, filed on Nov. 02, 2005, all in the Korean Intellectual Property Office, the entire contents of which are incorporated herein by reference.

### BACKGROUND OF THE INVENTION

1. Field of the Invention

The present invention relates to a plasma display and a driving method thereof.

2. Description of the Related Art

A plasma display is a flat panel display that uses plasma generated by a gas discharge process to display characters or images. In general, one frame of the plasma display is divided into a plurality of subfields. Turn-on/turn-off cells (i.e., cells to be turned on or off) are selected during an address period of each subfield, and a sustain discharge operation is performed on the turn-on cells so as to display an image during a sustain period.

Specifically, since a high-level voltage and a low-level voltage are alternately applied to an electrode on which the sustain discharge operation is performed during the sustain period, a voltage of a transistor for applying the high and low voltages is required to correspond to a difference between the high level and the low level. Accordingly, the cost of a sustain discharge circuit is increased due to the high voltage of the transistor.

### SUMMARY OF THE INVENTION

In accordance with the present invention a plasma display device is provided which may use a transistor having a low voltage in a sustain discharge circuit, and a driving method thereof.

An exemplary plasma display device according to an embodiment of the present invention includes a first transistor, a second transistor, a capacitor, a charging path, a third transistor, and a fourth transistor. The first transistor has a first terminal electrically coupled to a first power source for supplying a first voltage. The second transistor has a first terminal electrically coupled to a second terminal of the first transistor and a second terminal electrically coupled to a second power source for supplying a second voltage. The capacitor is charged with a third voltage and has a first terminal electrically coupled to a node of the first transistor and the second transistor. The charging path is electrically coupled between the first power source and a second terminal of the capacitor. The third transistor is electrically coupled between the second terminal of the capacitor and the plurality of first electrodes. The fourth transistor is electrically coupled between the plurality of first electrodes and the first terminal of the capacitor. The charging path includes a diode having an anode electrically coupled to the first power source and a cathode electrically coupled to the second terminal of the capacitor.

In addition, the exemplary plasma display device may further include a controller for setting the second and fourth transistors to be turned on during a first period, setting the third transistor to be turned on during a second period, setting the first and third transistors to be turned on during a third period, and setting the third transistor to be turned on during a fourth period.

The exemplary plasma display device may further include an inductor having a first terminal electrically coupled to the plurality of first electrodes, a fifth transistor electrically coupled between the second terminal of the capacitor and a second terminal of the inductor, and a sixth transistor electrically coupled between the second terminal of the inductor and the first terminal of the capacitor. The exemplary plasma display device may further include a controller for setting the second and fourth transistors to be turned on during a first period, setting the first and fifth transistors to be turned on during a second period, setting the first and third transistors to be turned on during a third period, and setting the first and sixth transistors to be turned on during a fourth period. In addition, the controller may set the second and fourth transistors to be turned on during a first period, set the first and sixth transistors to be turned on during a second period, set the second and third transistors to be turned on during a third period, set the first and fifth transistors to be turned on during a fourth period, set the first and third transistors to be turned on during a fifth period, and set the first and sixth transistors to be turned on during a sixth period.

The exemplary plasma display device may further include a fifth transistor having a first terminal electrically coupled to the plurality of first electrodes, an inductor having a first terminal electrically coupled to a second terminal of the fifth transistor, and a sixth transistor electrically coupled between the first terminal of the capacitor and a second terminal of the inductor. The exemplary plasma display device may further include a controller for setting the second and fourth transistors to be turned on during a first period, setting the first and sixth transistors to be turned on during a second period, setting the first and third transistors to be turned on during a third period, and setting the first and fifth transistors to be turned on during a fourth period.

In an exemplary driving method of a plasma display device having a first electrode and a second electrode according to another exemplary embodiment of the present invention, a first voltage is applied to the first electrode through a first power source for supplying the first voltage, a third voltage corresponding to a sum of the first voltage and a second voltage is applied to the first electrode through the first power source and a capacitor being charged with the second voltage, the first voltage is applied to the first electrode through the first power source, and a fourth voltage that is lower than the first voltage is applied to the first electrode. When the fourth voltage is applied to the first electrode, the capacitor is charged with the second voltage through the first power source.

In an exemplary driving method of a plasma display device according to still another exemplary embodiment of the present invention, energy stored in a first power source for supplying a first voltage and a capacitor being charged with a second voltage is supplied to the first electrode through an inductor coupled to the first electrode, a voltage at the first electrode is increased, a third voltage corresponding to a sum of the first voltage and the second voltage is applied to the first electrode through the first power source and the capacitor, energy stored in the first electrode is recovered to the first power source through the inductor, the voltage at the first electrode is decreased, and a fourth voltage that is lower than the first voltage is applied to the first electrode. When the fourth voltage is applied to the first electrode, the capacitor is charged with the second voltage through the first power source.

In an exemplary driving method of a plasma display device having a first electrode and a second electrode according to a further embodiment of the present invention, energy stored in a first power source for supplying a first voltage is supplied to the first electrode through an inductor electrically coupled to the first electrode, a voltage at the first electrode is increased, a third voltage corresponding to a sum of the first voltage and a second voltage is applied to the first electrode through the first power source and a capacitor being charged with the second voltage, energy stored in the first electrode is recovered to the power source through the inductor, the voltage at the first electrode is decreased, and a fourth voltage that is lower than the first voltage is applied to the first electrode. When the fourth voltage is applied to the first electrode, the capacitor is charged with the second voltage through the first power source.

### BRIEF DESCRIPTION OF THE DRAWINGS

FIG. 1 shows a diagram of a configuration of a plasma display according to an exemplary embodiment of the present invention.

FIG. 2 shows a diagram representing sustain pulses according to a first exemplary embodiment of the present invention.

FIG. 3 shows a circuit diagram of a sustain discharge circuit according to the first exemplary embodiment of the present invention.

FIG. 4 shows a signal timing diagram of the sustain discharge circuit according to the first exemplary embodiment of the present invention.

FIGS. 5A, 5B, 5C and 5D show diagrams respectively representing operations of the sustain discharge circuit shown in FIG. 3 according to signal timings shown in FIG. 4.

FIG. 6 shows a diagram representing sustain pulses according to a second exemplary embodiment of the present invention.

FIG. 7 shows a circuit diagram of a sustain discharge circuit according to the second exemplary embodiment of the present invention.

FIG. 8 shows diagram representing sustain pulses according to a third exemplary embodiment of the present invention.

FIG. 9 shows a schematic circuit diagram representing a sustain discharge circuit according to the third exemplary embodiment of the present invention.

FIG. 10 shows a diagram representing signal timing of the sustain discharge circuit according to the third exemplary embodiment of the present invention.

FIGS. 11A, 11B, 11C and 11D respectively show diagrams representing the operation of the sustain discharge circuit shown in FIG. 9 in response to the signal timing shown in FIG. 10.

FIG. 12 shows a diagram representing signal timing of a sustain discharge circuit according to a fourth exemplary embodiment of the present invention.

FIGS. 13A, 13B and 13C respectively show operations of the sustain discharge circuit shown in FIG. 9 according to the signal timings shown in FIG. 12.

FIG. 14 shows a diagram representing sustain pulses according to a fifth exemplary embodiment of the present invention.

FIG. 15 shows a schematic circuit diagram representing a sustain discharge circuit according to the fifth exemplary embodiment of the present invention.

FIG. 16 shows a schematic circuit diagram of a sustain discharge circuit according to the sixth exemplary embodiment of the present invention.

FIG. 17 shows a diagram representing signal timing of the sustain discharge circuit according to the sixth exemplary embodiment of the present invention.

FIGS. 18A, 18B, 18C and 18D respectively show operations of the sustain discharge circuit shown in FIG. 16 according to the signal timings shown in FIG. 17.

FIG. 19 shows a schematic circuit diagram of a sustain discharge circuit according to a seventh exemplary embodiment of the present invention.

### DETAILED DESCRIPTION OF THE EMBODIMENTS

Hereinafter, when it is described that an element is coupled to another element, the element may be directly coupled to the other element or electrically coupled to the other element through a third element.

Further, when it is described in the specification that a voltage is maintained, it should be understood not to strictly imply that the voltage is maintained exactly at a predetermined voltage. On the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art. In addition, since threshold voltages of semiconductor elements (e.g., a transistor and a diode) are very low compared to a discharge voltage, they are considered to be 0V.

A plasma display according to an exemplary embodiment of the present invention, and a driving apparatus and a driving method thereof, will now be described with reference to the figures.

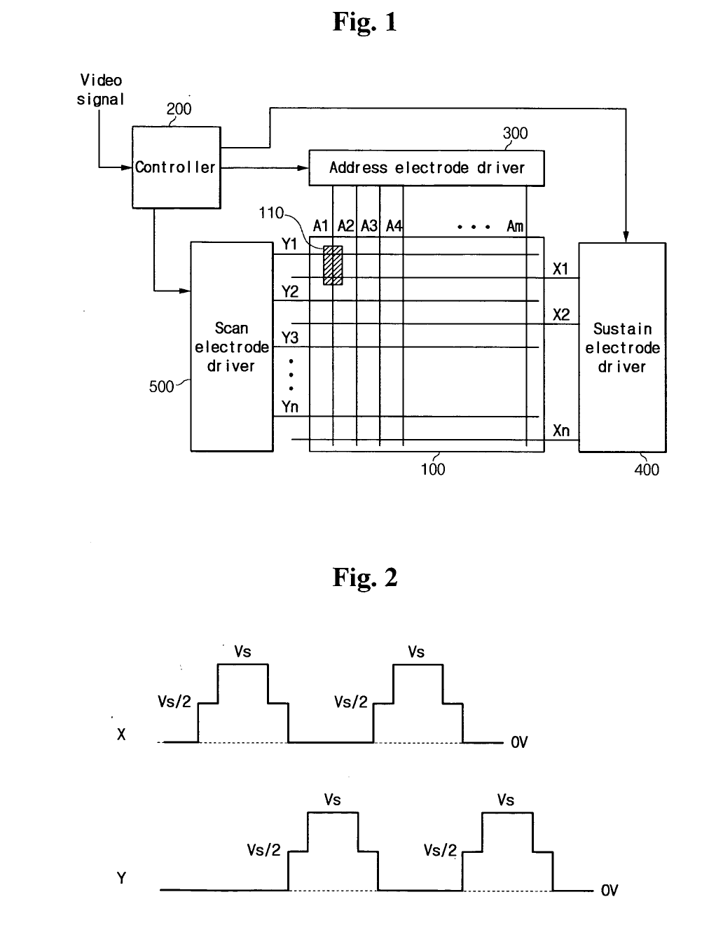

Referring now to FIG. 1, a plasma display according to an exemplary embodiment of the present invention includes a plasma display panel (PDP) 100, a controller 200, an address electrode driver 300, a sustain electrode driver 400, and a scan electrode driver 500.

The PDP 100 includes a plurality of address electrodes A1 to Am (hereinafter, referred to as “A electrodes”) extending in a column direction, and a plurality of sustain and scan electrodes X1 to Xn and Y1 to Yn (hereinafter, referred to as “X electrodes” and “Y electrodes”) extending in a row direction in pairs. In general, the X electrodes X1 to Xn respectively correspond to the Y electrodes Y1 to Yn, and the Y and X electrodes Y1 to Yn and X1 to Xn are arranged to cross the A electrodes A1 to Am. In this case, a discharge space on a crossing region of the A electrodes A1 to Am and the X and Y electrodes X1 to Xn and Y1 to Yn forms a discharge cell 110.

The controller 200 receives an external video signal, outputs a driving control signal, divides a frame into a plurality of subfields respectively having a brightness weight value, and drives them. Each subfield has an address period and a sustain period. The A, X, and Y electrode drivers 300, 400, 500 respectively apply a driving voltage to the A electrodes A1 to Am, the X electrodes X1 to Xn, and the Y electrodes Y1 to Yn in response to the driving control signals from the controller 200.

During the address period of each subfield, the A, X, and Y electrode drivers 300, 400, 500 select the turn-on discharge cell and the turn-off discharge cell from among a plurality of discharge cells 110. During the sustain period of each subfield, a representative portion of which is shown in FIG. 2, the X electrode driver 400 applies a sustain pulse alternately having a high-level voltage (Vs) and a low-level voltage (0V) to the plurality of X electrodes X1 to Xn a number of times corresponding to a weight value of the corresponding subfield. The Y electrode driver 500 applies the sustain pulse having a reverse phase of the sustain pulse applied to the X electrodes X1 to Xn to the plurality of Y electrodes Y1 to Yn. Accordingly, a voltage difference between the Y electrodes and the X electrodes alternately becomes a Vs voltage and a −Vs voltage, and the sustain discharge is repeatedly generated on the turn-on discharge cell a predetermined number of times.

FIG. 2 shows a diagram representing sustain pulses according to a first exemplary embodiment of the present invention.

As shown in FIG. 2, while the sustain pulse according to the first exemplary embodiment of the present invention is increased from the low-level voltage (0V) to the high-level voltage (Vs) and is decreased from the high-level voltage (Vs) to the low-level voltage (0V), it stops increasing and decreasing at an intermediate level voltage (Vs/2) for a predetermined time. That is, the sustain pulse has three levels including the low-level voltage 0V, the intermediate level voltage (Vs/2), and the high-level voltage (Vs). Accordingly, a transistor having a low voltage, as will be described, may be used.

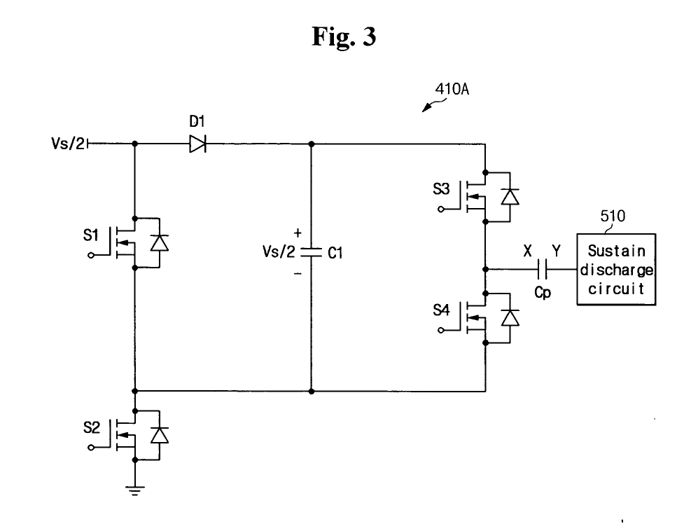

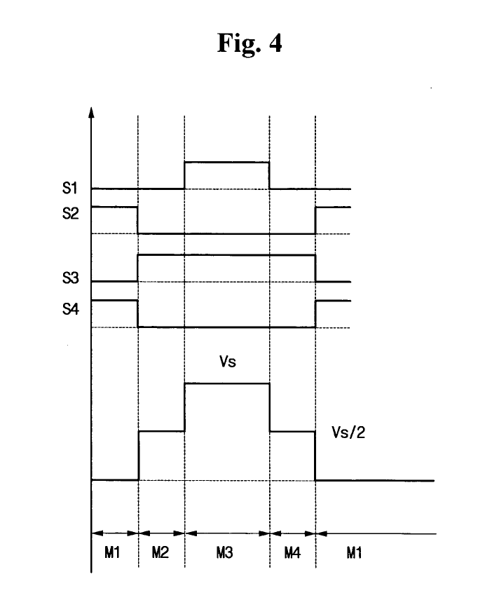

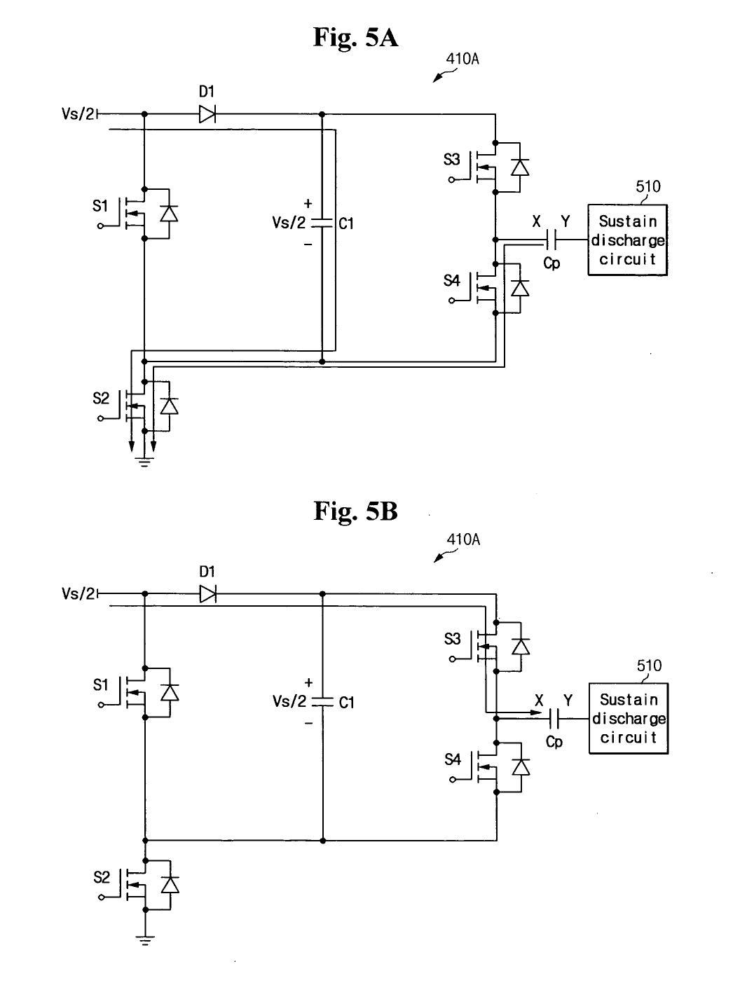

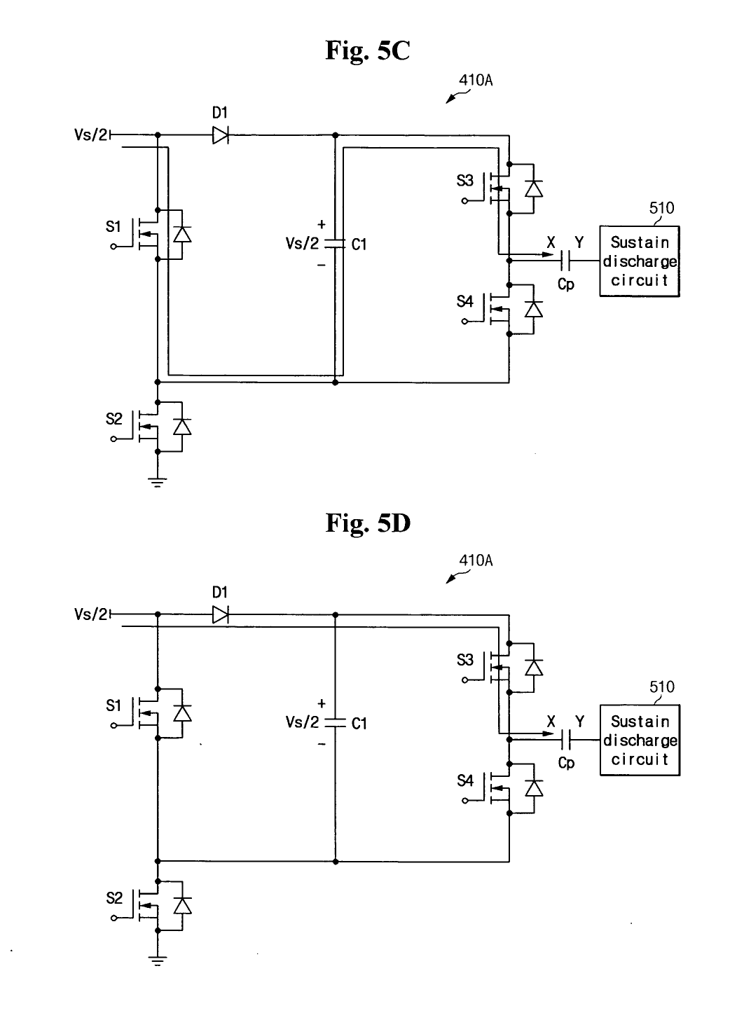

A sustain discharge circuit for supplying the sustain pulse shown in FIG. 2 will now be described with reference to FIG. 3, FIG. 4, and FIG. 5A to FIG. 5D.

FIG. 3 shows a circuit diagram of a sustain discharge circuit 41 OA according to the first exemplary embodiment of the present invention. For better understanding and ease of description, the sustain discharge circuit coupled to the plurality of X electrodes X1 to Xn is only illustrated in FIG. 3, and the sustain discharge circuit 410A may be formed in the X electrode driver 400 shown in FIG. 1. A sustain discharge circuit 510 coupled to the plurality of Y electrodes Y1 to Yn may have the same configuration as the sustain discharge circuit 410A in FIG. 3, or it may have another configuration that is different from the sustain discharge circuit 410A shown in FIG. 3.

The sustain discharge circuit 410A may be commonly coupled to the plurality of X electrodes X1 to Xn, or it may be coupled to some of the plurality of X electrodes X1 to Xn. In addition, for better understanding and ease of description, one X electrode X and one Y electrode Y are illustrated in the sustain discharge circuit 410A, and a capacitance formed by the X and Y electrodes X and Y is illustrated by a panel capacitor Cp.

As shown in FIG. 3, the sustain discharge circuit 410A according to the first exemplary embodiment of the present invention includes transistors S1, S2, S3, S4, a diode D1, and a capacitor C1. The transistors S1 to S4 are illustrated as an n-channel field effect transistor in FIG. 3, specifically as an n-channel metal oxide semiconductor transistor (NMOS) with a body diode formed in the transistors S1 to S4 in a direction from a source to a drain. Rather than using the NMOS transistor, other transistors that can perform a similar function may be used for the transistors S1, S2, S3, S4. The transistors S1, S2, S3, S4 are respectively illustrated as one transistor in FIG. 3. However, the respective transistors S1, S2, S3, S4 may be formed by a plurality of transistors coupled in parallel to each other.

Referring to FIG. 3, a drain of the transistor S1 is coupled to a power source for supplying a Vs/2 voltage corresponding to a half of a difference between the high-level voltage (Vs) and the low-level voltage (0V). In this case, the power source may be provided by a capacitor coupled to an output terminal of a switching mode power supply (SMPS, not shown). A source of the transistor S1 is coupled to a drain of the transistor S2, and a source of the transistor S2 is coupled to a ground terminal for supplying a low-level voltage (i.e., a ground voltage 0V). A first terminal of the capacitor C1 is coupled to the source of the transistor S1 and the drain of the transistor S2. A second terminal of the capacitor C1 is coupled to a cathode of the diode D1, and an anode of the diode D1 is coupled to the power source providing a Vs/2 voltage. In this case, the diode D1 forms a charging path for charging the capacitor C1 to a Vs/2 voltage when the transistor S2 is turned on, and the capacitor C1 is charged to the Vs/2 voltage through the charging path. Rather than using the diode D1, other elements (e.g., a transistor) for forming the charging path may be used. The two transistors S1, S2 operate as switching units for selectively applying the Vs/2 voltage and the 0V voltage to the first terminal of the capacitor C1.

The X electrode is coupled to a source of the transistor S3 and a drain of the transistor S4. A drain of the transistor S3 is coupled to the second terminal of the capacitor C1. A source of the transistor S4 is coupled to the first terminal of the capacitor.

An operation of the sustain discharge circuit 410A shown in FIG. 3 will now be described with reference to FIG. 4 and FIG. 5A to FIG. 5D.

FIG. 4 shows a signal timing diagram of the sustain discharge circuit 410A according to the first exemplary embodiment of the present invention, and FIG. 5A to FIG. 5D show diagrams respectively representing operations of the sustain discharge circuit 410A shown in FIG. 3 according to signal timings shown in FIG. 4.

Referring to FIG. 4 and FIG. 5A, since the transistors S2 and S4 are turned on at a first mode M1, the 0V voltage is applied to the X electrode through a path from the X electrode, through the transistor S4 and the transistor S2, to the ground terminal. In addition, as shown in FIG. 5A, the capacitor C1 is charged with the Vs/2 voltage through a path from the power source providing the Vs/2 voltage, through the diode D1, the capacitor C1 and the transistor S2, to the ground terminal. In this case, since voltages at the drains of the transistors S2, S4 are the 0V voltage and voltages at the drains of the transistors S1, S3 are the Vs/2 voltage, the Vs/2 voltage is applied between the drain and the source of the turned-off transistors S1 and S3. Accordingly, the transistors S1, S3 having a Vs/2 voltage may be used.

At a second mode M2, since the transistors S2, S4 are turned off and the transistor S3 is turned on, as shown in FIG. 5B, the Vs/2 voltage is applied to the X electrode through a path from the power source providing the Vs/2 voltage, through the diode D1 and the transistor S3, to the X electrode. In this case, since the drains of the transistors S1, S4 are the Vs/2 voltage, a voltage that is lower than the Vs/2 voltage is applied between the drains and sources of the turn-off transistors S1, S2, S4. Accordingly, the transistors S1, S3, S4 having the Vs/2 voltage may be used.

At a third mode M3, since the transistor S1 is turned on while the transistor S3 is turned on, as shown in FIG. 5C, the Vs voltage is applied to the X electrode through a path from the power source providing the Vs/2 voltage, through the transistor S1, the capacitor C1 and the transistor S3, to the X electrode. Since the transistor S1 is turned on, the first terminal of the capacitor C1 becomes the Vs/2 voltage, the second terminal of the capacitor C1 becomes the Vs voltage, and the Vs voltage is applied to the X electrode. In this case, since a voltage at the drain of the transistor S2 is the Vs/2 voltage and a voltage at the drain of the transistor S4 is the Vs voltage, the Vs/2 voltage is applied between the drains and the sources of the turn-off transistors S2, S4. Accordingly, the transistors S2, S4 having a Vs/2 voltage may be used.

At a fourth mode M4, since the transistor S1 is turned off while the transistor S3 is turned on, as shown in FIG. 5D, the Vs/2 voltage is applied to the X electrode through a path from the power source providing the Vs/2 voltage, through the diode D1 and the transistor S3, to the X electrode. In this case, since the drains of the transistors S1, S4 are the Vs/2 voltage, the voltage that is lower than the Vs/2 is applied between the drains and the sources of the turn-off transistors S1, S2, S4. Accordingly, the transistors S1, S2, S4 having a Vs/2 voltage may be used.

As described, according to the first exemplary embodiment of the present invention, the Vs voltage and the 0V voltage are alternately applied to the X electrode since the first mode M1 to the fourth mode M4 are repeatedly performed a number of times corresponding to a weight value of a corresponding subfield during the sustain period.

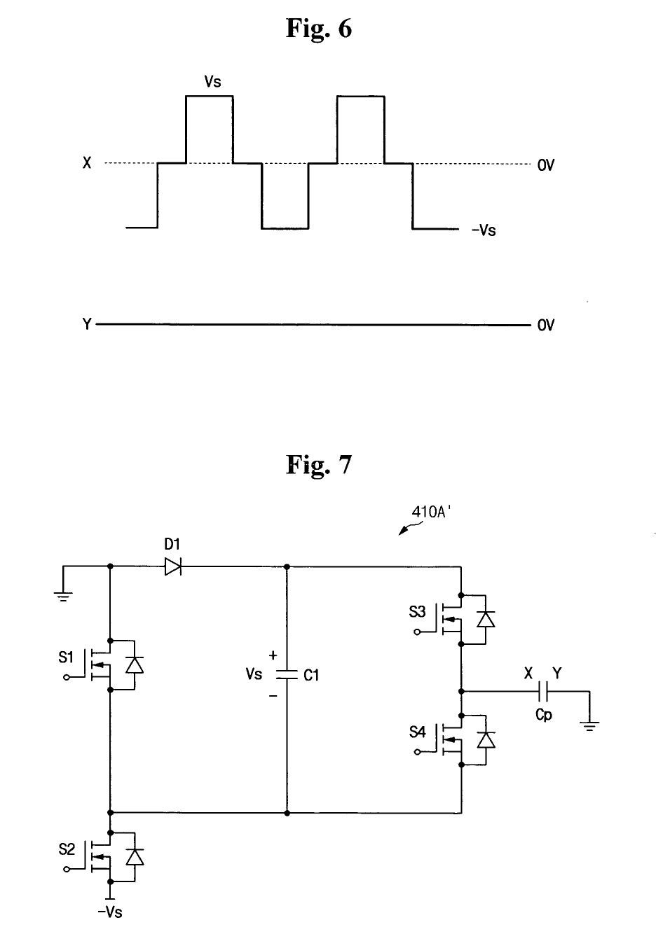

Referring now to FIG. 6 and FIG. 7, while it has been described that the sustain pulse alternately has the high-level voltage and the low-level voltage and the sustain pulses of reverse phases are respectively applied to the X electrode and the Y electrode in the first exemplary embodiment of the present invention, the sustain pulse may be alternatively applied to only one of the X electrode and the Y electrode.

FIG. 6 shows a diagram representing a sustain pulse according to a second exemplary embodiment of the present invention, and FIG. 7 shows a circuit diagram of a sustain discharge circuit 410A′ according to the second exemplary embodiment of the present invention.

As shown in FIG. 6, a sustain pulse alternately having the Vs voltage and a −Vs voltage is applied to the plurality of X electrodes X1 to Xn during the sustain period according to the second exemplary embodiment of the present invention, and the 0V voltage is applied to the plurality of Y electrodes Y1 to Yn. In addition, the 0V voltage which is an intermediate level between the Vs and −Vs voltages is applied for a predetermined time before the Vs voltage is applied after the −Vs voltage is applied, and the intermediate level voltage 0V is applied for a predetermined time before the −Vs voltage is applied after the Vs voltage is applied. Accordingly, a voltage difference between the X and Y electrodes alternately becomes the Vs voltage and the −Vs voltage similar to that of the sustain pulses shown in FIG. 2.

Referring to FIG. 7, the sustain discharge circuit 410A′ according to the second exemplary embodiment of the present invention is the same as that according to the first exemplary embodiment of the present invention, except for a voltage supplied by a power source and a voltage charged to the capacitor C1. The drain of the transistor S1 is coupled to the ground terminal, and the source of the transistor S2 is coupled to a power source −Vs for supplying the −Vs voltage. Accordingly, the −Vs voltage and the 0V voltage are selectively applied to the first terminal of the capacitor C1 according to an operation of the transistors S1, S2. When the transistor S2 is turned on, the capacitor C1 is charged with the Vs voltage by the diode D1.

Accordingly, the Vs voltage is applied to the X electrode through the ground terminal, the transistor S1, the capacitor C1, and the transistor S3 at the third mode M3 shown in FIG. 4, and the −Vs voltage is applied to the X electrode through the transistor S4, the transistor S2, and the power source −Vs at the first mode M1. In addition, in this case, a voltage that is lower than a voltage of Vs corresponding to a half of a difference between the high-level voltage Vs and the low-level voltage −Vs is applied between the drain and source of the turn-off transistor. Accordingly, the sustain discharge circuit 410A′ according to the second exemplary embodiment of the present invention may alternately apply the Vs voltage and the −Vs voltage to the X electrode, and it may use a transistor having a low voltage.

While it has been assumed that the sustain discharge circuit 410′ is coupled to the X electrode and the 0V voltage is applied to the Y electrode in FIG. 6 and FIG. 7, the sustain discharge circuit may be coupled to the Y electrode and the 0V voltage may be applied to the X electrode.

In addition, when the source of the transistor S2 is coupled to a power source for supplying the −Vs/2 voltage in the circuit shown in FIG. 7, the sustain pulse alternately having the Vs/2 voltage and the −Vs/2 voltage may be applied to the X electrode. In this case, the sustain pulse having a reverse phase of the sustain pulse applied to the X electrode may be applied to the Y electrode.

In the first and second exemplary embodiments of the present invention, the high-level voltage Vs and the low-level voltage 0V of the sustain pulse are applied without recovering energy by an LC resonance. A sustain discharge circuit for performing an energy recovering operation by the LC resonance will now be described.

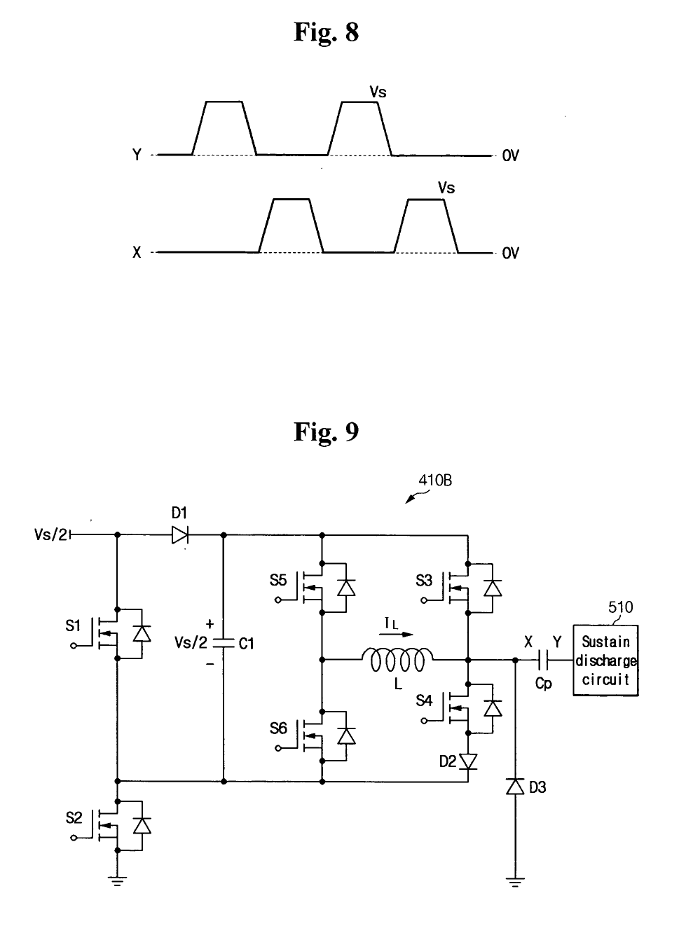

FIG. 8 shows a diagram representing a sustain pulse according to a third exemplary embodiment of the present invention.

The sustain pulse according to the third exemplary embodiment of the present invention gradually varies by the LC resonance when it is increased from the low-level voltage 0V to the high-level voltage Vs and it is decreased from the high-level voltage Vs to the low-level voltage 0V.

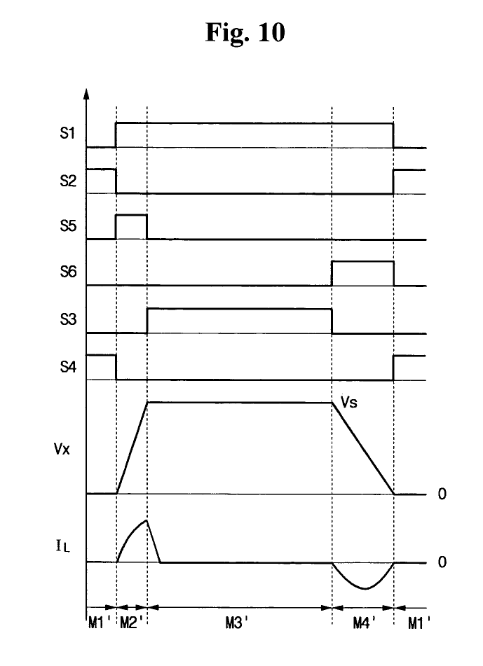

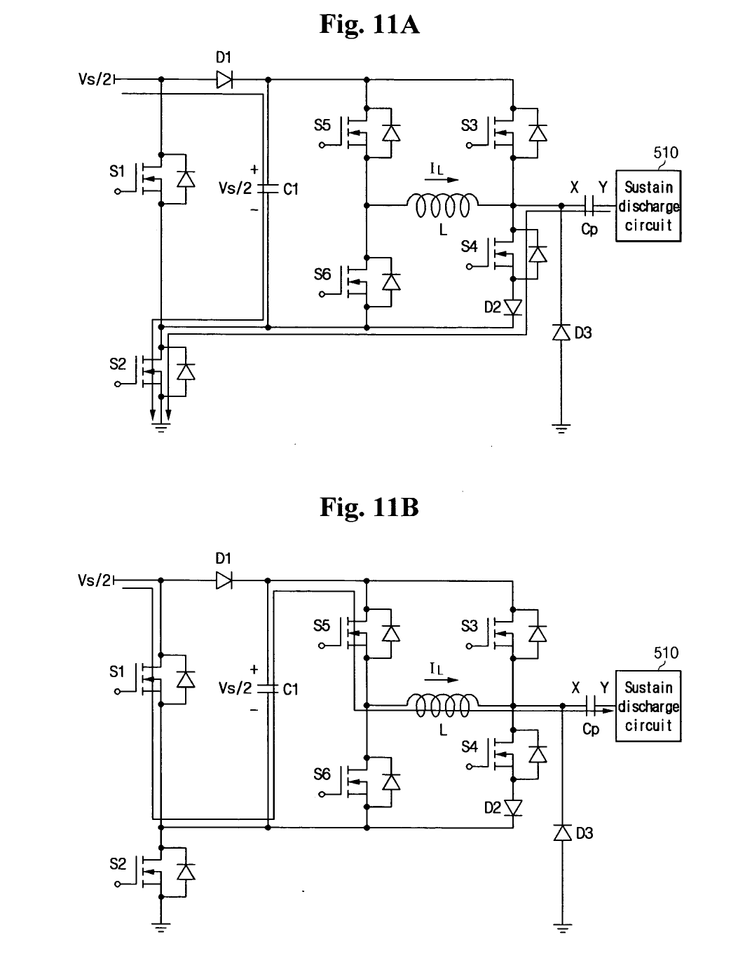

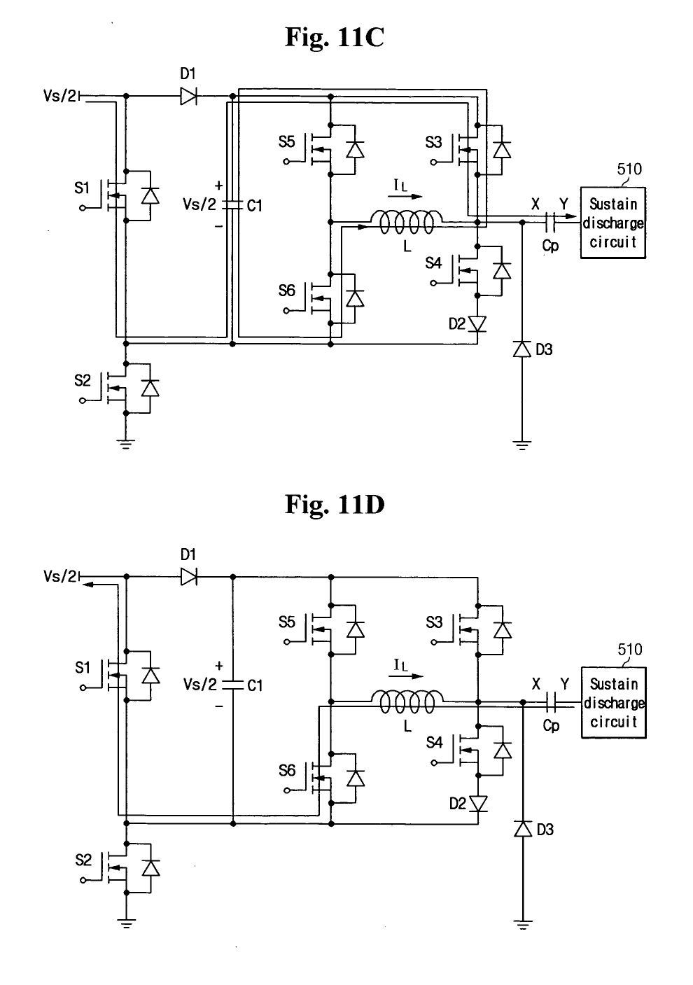

A sustain discharge circuit for applying the sustain pulse shown in FIG. 8 will now be described with reference to FIG. 9, FIG. 10, and FIG. 11 A to FIG. 11 D.

FIG. 9 shows a schematic circuit diagram representing a sustain discharge circuit 410B according to the third exemplary embodiment of the present invention. For better understanding and ease of description, the sustain discharge circuit coupled to the plurality of X electrodes X1 to Xn is only illustrated in FIG. 3, and the sustain discharge circuit 410B may be formed in the X electrode driver 400 shown in FIG. 1. A sustain discharge circuit 510 coupled to the plurality of Y electrodes Y1 to Yn may have the same configuration as the sustain discharge circuit 410B in FIG. 9, or it may have another configuration that is different from the sustain discharge circuit 410B shown in FIG. 9.

As shown in FIG. 9, the sustain discharge circuit 410B according to the third exemplary embodiment of the present invention includes transistors S1, S2, S3, S4, S5, S6, diodes D1, D2, D3, an inductor L, and a capacitor C1. The sustain discharge circuit 410B according to the third exemplary embodiment of the present invention is the same as that of the sustain discharge circuit 410A according to the first exemplary embodiment of the present invention except that the sustain discharge circuit 410B additionally includes the transistors S5, S6, the inductor L, and the diodes D2, D3. Accordingly, parts having been previously described will not be discussed further.

A first terminal of the inductor L is coupled to the X electrode, and a second terminal of the inductor L is coupled to a source of the transistor S5 and a drain of the transistor S6. Drains of the transistors S3, S5 coupled to a second terminal of the capacitor C1, and sources of the transistors S4, S6 are coupled to a node of the capacitor C1 and the transistors S1, S2. In this case, the diode D2 and the transistor S4 may be coupled in series to interrupt a current path formed by a body diode of the transistor S4, as shown in FIG. 9. In addition, since the diode D2 may interrupt a path for clamping the voltage at the X electrode (i.e., the first terminal of the inductor L) to be 0V, a clamping diode D3 is coupled between the X electrode and the ground terminal as shown in FIG. 9.

An operation of the sustain discharge circuit 410B shown in FIG. 9 will now be described with reference to FIG. 10 and FIG. 11A to FIG. 11D.

FIG. 10 shows a diagram representing signal timing of the sustain discharge circuit 410B according to the third exemplary embodiment of the present invention, and FIG. 11 A to FIG. 11D respectively show diagrams representing the operation of the sustain discharge circuit 410B shown in FIG. 9 in response to the signal timing shown in FIG. 10.

Referring to FIG. 10 and FIG. 11A, at a first mode M1′, the transistors S2 and S4 are turned on, and 0V is applied to the X electrode through a path from the X electrode, through the transistor S4, the diode D2, and the transistor S2, to the ground terminal as shown in FIG. 11A. In addition, the capacitor C1 is charged with the Vs/2 voltage through a path of from the power source providing the Vs/2 voltage, through the diode D1, the capacitor C1 and the transistor S2, to the ground terminal. In this case, since a voltage at a drain of the transistor S2 is the 0V and a voltage at drains of the transistors S3, S5 is the Vs/2 voltage, the voltage that is lower than the Vs/2 is applied between drains and sources of the turn-off transistors S1, S3, S5, S6. That is, the transistors S1, S3, S5, S6 having a Vs/2 voltage may be used.

Referring to FIG. 10 and FIG. 11B, at a second mode M2′, since the transistors S2 and S4 are turned off and the transistors S1, S5 are turned on, a resonance is generated through a path from the power source providing the Vs/2 voltage, through the transistor S1, the capacitor C1, the transistor S5 and the inductor L, to the panel capacitor Cp as shown in FIG. 11B. Then, since energy I_{L} charged in the capacitor C1 and the Vs/2 voltage is provided to the X electrode through the inductor L, the voltage Vx at the X electrode is increased from the 0V to the Vs voltage. In this case, since the capacitor C1 and the Vs/2 voltage are coupled in series to supply the Vs voltage, the voltage Vx at the X electrode may be increased to the Vs voltage during a period corresponding to a quarter of a resonance period when the sustain discharge circuit 410B has no parasitic component. That is, the voltage Vx at the X electrode may be quickly increased to the Vs voltage compared to when a resonance is formed with the Vs/2 voltage. In addition, since the voltage Vx at the X electrode may be increased to a 2Vs voltage when the sustain discharge circuit 410B has no parasitic component, the voltage Vx at the X electrode may be sufficiently increased to the Vs voltage when the sustain discharge circuit 410B has the parasitic component. When the voltage Vx at the X electrode is increased to greater than the Vs voltage, the voltage Vx at the X electrode may be clamped to the Vs voltage by the body diode of the transistors S1, S3.

At a third mode M3′, since the transistor S3 is turned on and the transistor S5 is turned off while the transistor S1 is turned on, the Vs voltage is applied to the X electrode through a path from the power source providing the Vs/2 voltage, through the transistor S1, the capacitor C1, and the transistor S3, to the X electrode, as shown in FIG. 11C. In this case, since the transistor S3 is turned on when the voltage Vx at the X electrode is the Vs voltage, the transistor S3 may be soft-switched. At the second mode M2′, when the voltage Vx at the X electrode is increased to the Vs voltage, a remaining current I_{L} in the inductor L is free-wheeled through the body diode of the transistor S3, the capacitor C1, and the body diode of the transistor S6. That is, the remaining energy in the inductor L is recovered to the capacitor C1. In this case, since the voltage at the drain of the transistor S2 is the Vs/2 voltage and the voltage at the drain of the transistor S5 is the Vs voltage, the voltage that is lower than the Vs/2 voltage is applied between the drains and the sources of the turn-off transistors S2, S4, S5, S6. That is, the transistors S2, S4, S5, S6 having a Vs/2 voltage may be used.

At a fourth mode M4′, since the transistor S3 is turned off and the transistor S6 is turned on while the transistor S1 is turned on, a resonance is generated through a path from the panel capacitor Cp, through the inductor L, the transistor S6 and the body diode of the transistor S1, to the power source Vs/2 as shown in FIG. 11D. Since the energy I_{L} stored in the panel capacitor Cp is recovered to the power source Vs/2 through the inductor L by the resonance, the voltage Vx at the X electrode is decreased from the Vs voltage to the 0V. In this case, the voltage Vx at the X electrode may be decreased to the 0V during a period corresponding to a half of the resonance period since the power source Vs/2 supplies the Vs/2 voltage.

As described, according to the third exemplary embodiment of the present invention, the Vs voltage and the 0V voltage may be alternately applied to the X electrode since the first mode M1′ to the fourth mode M4′ are repeatedly performed a number of times corresponding to a weight value of a corresponding subfield during the sustain period. In addition, the sustain discharge may be generated by quickly increasing the voltage Vx at the X electrode to the Vs voltage since a ¼ resonance is used at the second mode M2′, and a rate of energy recovery may be increased since a ½ resonance is used at the fourth mode M4′ before 0V having no relation to the sustain discharge is applied.

In the third exemplary embodiment of the present invention, as shown in FIG. 8, the sustain discharge circuit 510 coupled to the Y electrode may apply the 0V to the Y electrode while applying the Vs voltage to the X electrode, and apply the Vs voltage to the Y electrode while applying the 0V to the X electrode.

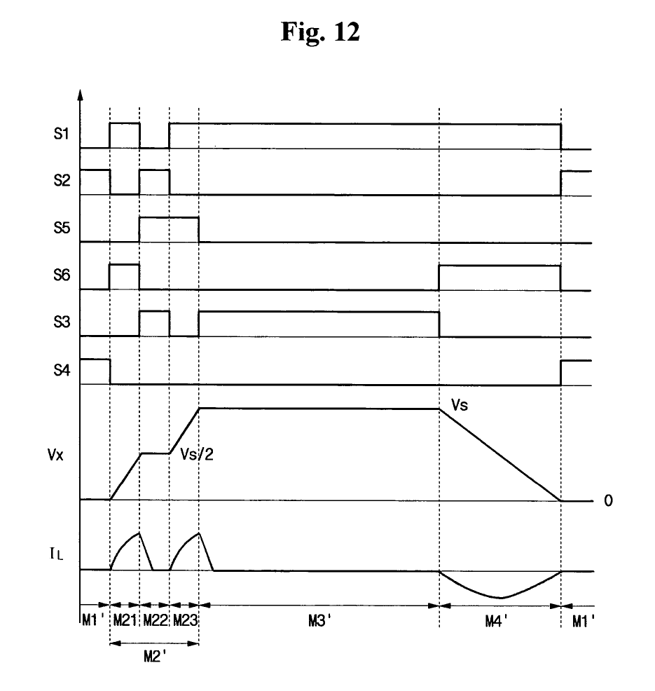

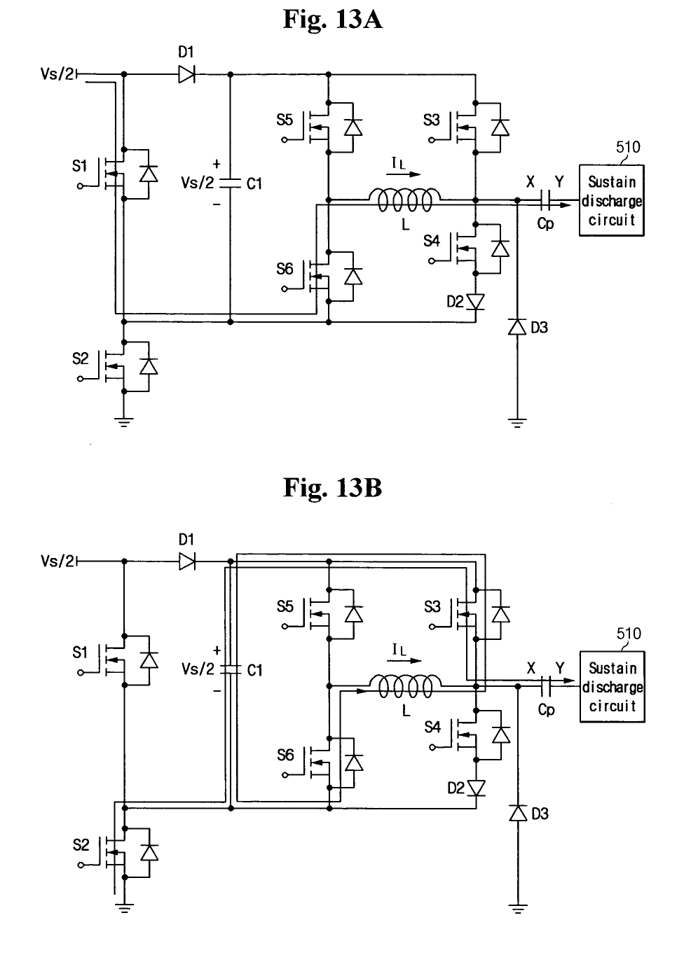

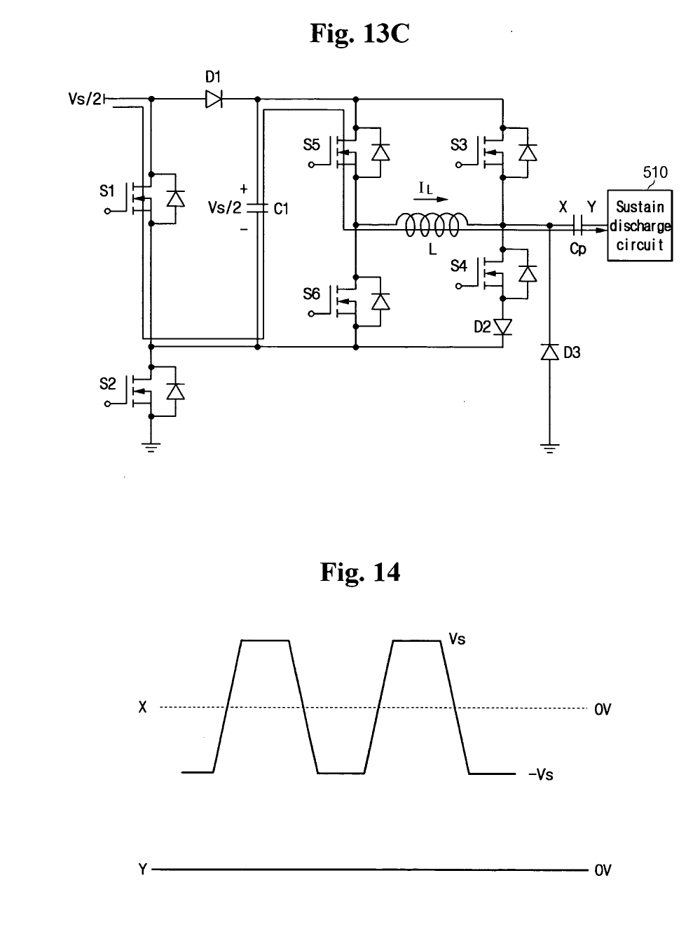

Referring now to FIG. 12 and FIG. 13A to FIG. 13C, while the voltage Vx at the X electrode is directly increased from the 0V to the Vs voltage at the second mode M2′ in the third exemplary embodiment of the present invention, the sustain discharge circuit shown in FIG. 9 may increase the voltage Vx at the X electrode step by step.

FIG. 12 shows a diagram representing signal timing of a sustain discharge circuit according to a fourth exemplary embodiment of the present invention, and FIG. 13A to FIG. 13C respectively show operations of the sustain discharge circuit shown in FIG. 9 according to the signal timings shown in FIG. 12.

As shown in FIG. 12, the second mode M2′ shown in FIG. 10 is divided into three modes M21, M22, M23 to perform the operation of the sustain discharge circuit according the fourth exemplary embodiment of the present invention, and the operation of the sustain discharge circuit at the other modes M1′, M3′, M4′ are the same as those of FIG. 10.

As shown in FIG. 12 and FIG. 13A, at a mode M21 of the second mode M2′, the transistors S2, S4 are turned off and the transistors S1, S6 are turned on. Then, as shown in FIG. 13A, a resonance is generated through the power source providing the Vs/2 voltage, the transistor S1, the body diode of the transistor S6, the inductor L, and the panel capacitor Cp. By this resonance, the energy I_{L} charged in the power source Vs/2 is provided to the X electrode through the inductor L, and the voltage Vx at the X electrode is increased. In this case, since the power source Vs/2 supplies the Vs/2 voltage, the voltage Vx at the X electrode may be increased to the Vs/2 voltage during a period corresponding to a quarter of the resonance period.

At a mode M22 of the second mode M2′, the transistors S2, S3 are turned on, the transistors S1, S6 are turned off, and a voltage at the first terminal of the capacitor C1 becomes the 0V. Then, as shown in FIG. 13B, the Vs/2 voltage is applied to the X electrode through a path of the capacitor C1 and transistor S3. After increasing the voltage Vx at the X electrode to the Vs/2 voltage at the mode M21, the remaining current I_{L} in the inductor L is free-wheeled through the inductor L, the body diode of the transistor S3, the capacitor C1, and the body diode of the transistor S6. That is, the remaining energy in the inductor L is recovered to the capacitor C1.

At a mode M23 of the second mode M2′, while the transistor S5 is turned on, the transistors S2 and S3 are turned off and the transistor S1 is turned on. Then, as shown in FIG. 13C the resonance is generated through the power source providing the Vs/2 voltage, the transistor S1, the capacitor C1, the transistor S5, the inductor L, and the panel capacitor Cp. By this resonance, the voltage Vx at the X electrode is increased since the energy I_{L} charged in the power source Vs/2 and capacitor C1 is provided to the X electrode through the inductor L. In this case, since the power source Vs/2 and capacitor C1 are coupled in series to supply the Vs voltage, the voltage Vx at the X electrode may be increased from the Vs/2 voltage to the Vs voltage during the period corresponding to a quarter of the resonance period.

Subsequently, as described in FIG. 10, at the third mode M3′, the transistors S1 and S3 are turned on, the transistor S5 is turned off, and the Vs voltage is applied to the X electrode through a path of the power source Vs/2, the transistor S1, the capacitor C1, and the transistor S3.

As described, according to the fourth exemplary embodiment of the present invention, the Vs voltage and the 0V voltage may be alternately applied to the X electrode since the first mode M1′, the modes M21, M22, M23 of the second mode M2′, the third mode M3′, and the fourth mode M4′ are repeatedly performed a number of times corresponding to a weight value of a corresponding subfield during the sustain period. The sustain discharge may be generated by quickly increasing the voltage Vx at the X electrode to the Vs voltage since the ¼ resonance is used at the modes M21 and M23 of the second mode M2′. Particularly, since the voltage Vx at the X electrode is directly increased from the Vs/2 voltage to the Vs voltage after it is increased from the 0V to the Vs/2 voltage, electromagnetic interference (EMI) may be reduced compared to when the voltage Vx at the X electrode is directly increased from the 0V to the Vs voltage.

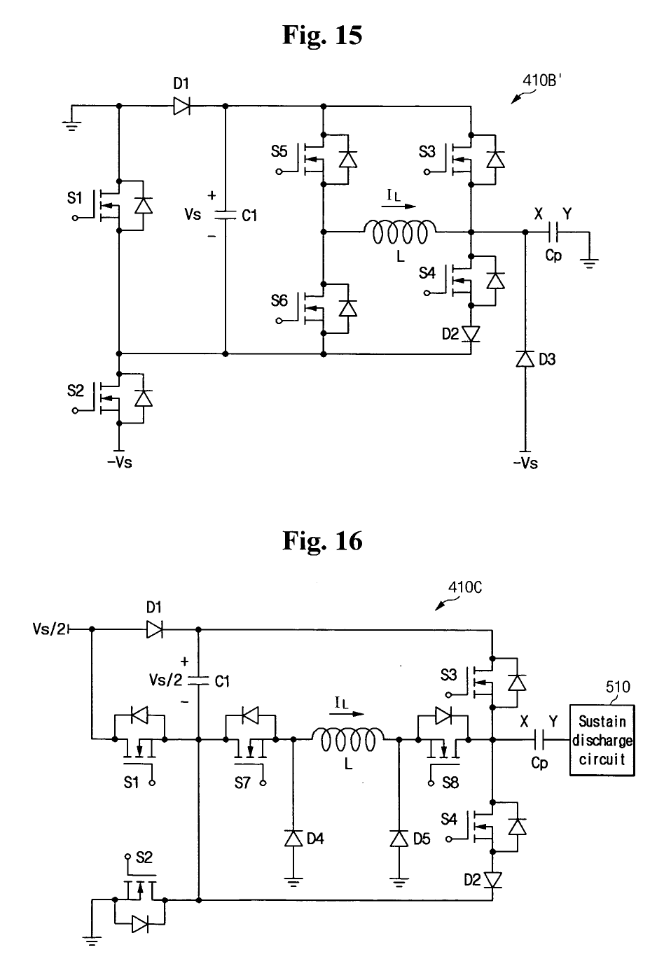

FIG. 14 shows a diagram representing a sustain pulse according to a fifth exemplary embodiment of the present invention, and FIG. 15 shows a schematic circuit diagram representing a sustain discharge circuit 410B′ according to the fifth exemplary embodiment of the present invention.

As shown in FIG. 14, according to the fifth exemplary embodiment of the present invention, the sustain pulse alternately having the Vs voltage and the −Vs voltage is applied to the plurality of X electrodes X1 to Xn during the sustain period, and the 0V is applied to the plurality of Y electrodes Y1 to Yn. Accordingly, a voltage difference between the X and Y electrodes alternately becomes the Vs voltage and the −Vs voltage in a like manner of the sustain pulses shown in FIG. 8.

In FIG. 15, the sustain discharge circuit 410B′ according to the fifth exemplary embodiment of the present invention is the same as that of the third exemplary embodiment of the present invention, except for the voltages supplied by the power source and charged in the capacitor C1. In further detail, the drain of the transistor S1 is coupled to the ground terminal, and the source of the transistor S2 is coupled to a power source for supplying the −Vs voltage. Accordingly, according to the operation of the transistors S1, S2, the −Vs voltage and the 0V voltage are selectively applied to the first terminal of the capacitor C1. When the transistor S2 is turned on, the Vs voltage may be charged in the capacitor C1 by the diode D1.

The Vs voltage may be applied to the X electrode through the ground-terminal, the transistor S1, the capacitor C1, and the transistor S3 at the third mode M3′ shown in FIG. 10, and the −Vs voltage may be applied to the X electrode through the transistor S4, the diode D2, the transistor S2, and the power source −Vs at the first mode M1′. In this case, a voltage that is lower than the Vs voltage corresponding to a half of the difference between the high-level voltage (Vs) and the low-level voltage (−Vs) is applied between the drain and the source of the turn-off transistor. Accordingly, the sustain discharge circuit 410B′ according to the fifth exemplary embodiment of the present invention alternately applies the Vs voltage and the −Vs voltage to the X electrode, and may use a transistor having the low voltage.

While it has been described that the sustain discharge circuit 410B′ is coupled to the X electrode and the 0V is applied to the Y electrode in FIG. 14 and FIG. 15, the sustain discharge circuit may be coupled to the Y electrode and the 0V may be applied to the X electrode.

In addition, when the source of the transistor S2 is coupled to a power source for supplying the −Vs/2 voltage in the circuit shown in FIG. 15, the sustain pulse alternately having the Vs/2 voltage and the −Vs/2 voltage may be applied to the X electrode. In this case, the sustain pulse alternately having the Vs/2 voltage and the −Vs/2 voltage and having an opposite phase of the sustain pulse applied to the X electrode may be applied to the Y electrode.

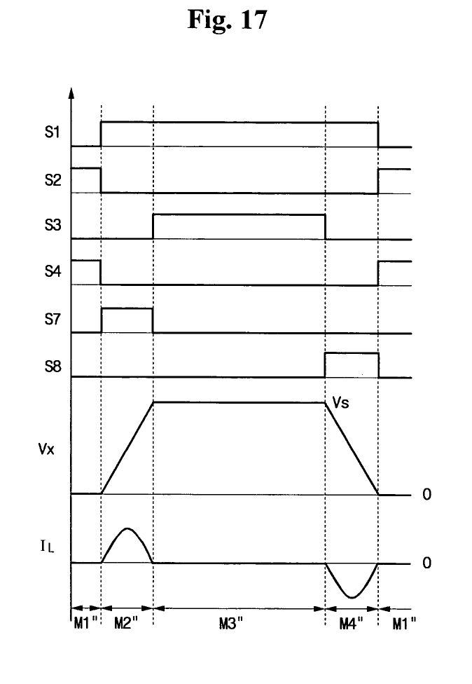

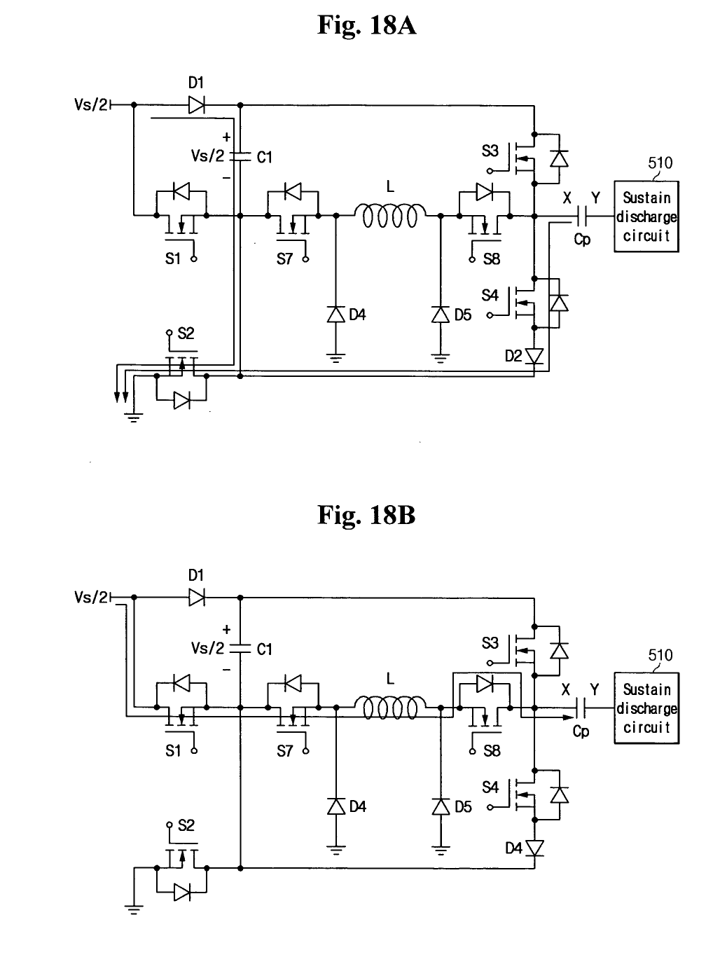

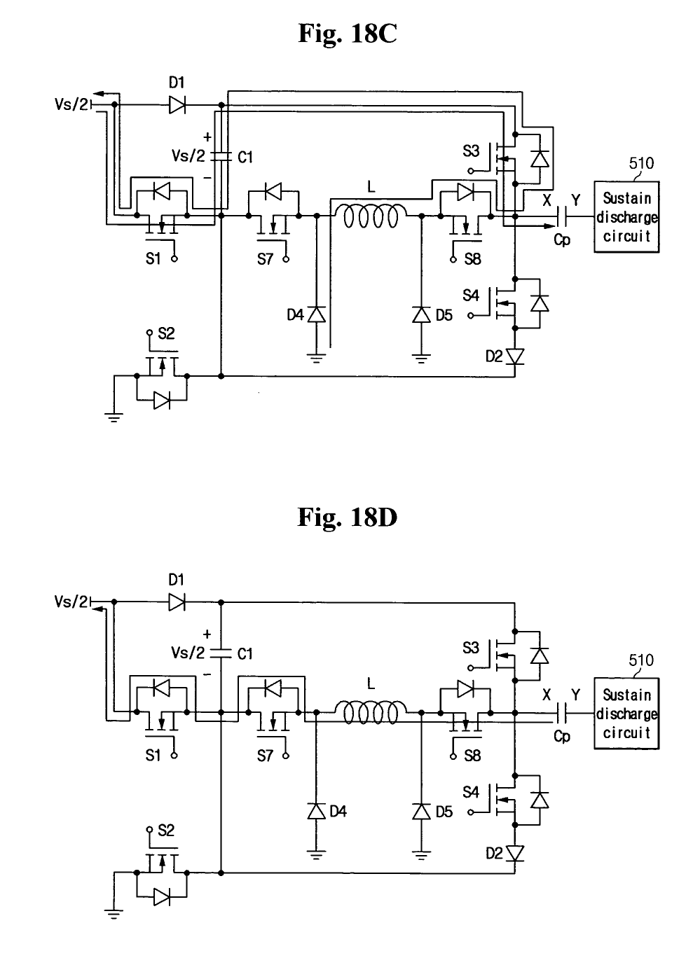

The sustain circuit for supplying the sustain pulse shown in FIG. 8 according to a sixth exemplary embodiment of the present invention will now be described with reference to FIG. 16, FIG. 17, and FIG. 18A to FIG. 18D.

FIG. 16 shows a schematic circuit diagram of a sustain discharge circuit 410C according to the sixth exemplary embodiment of the present invention.

As shown in FIG. 16, the sustain discharge circuit 410C according to the sixth exemplary embodiment of the present invention includes transistors S1, S2, S3, S4, S7, S8, diodes D1, D2, D4, D5, an inductor L, and a capacitor C1. The sustain discharge circuit 410C according to the sixth exemplary embodiment of the present invention is the same as the sustain discharge circuit 410A according to the first exemplary embodiment of the present invention except that the transistors S7, S8, the inductor the diodes D2, D4, D5 are additionally provided, and therefore, parts having been previously described above will not be discussed.

As shown in FIG. 16, the source of the transistor S3, the drain of the transistor S4, and a drain of the transistor S8 are coupled to the X electrode, and a source of the transistor S8 is coupled to the first terminal of the inductor L. A source of the transistor S7 is coupled to the second terminal of the inductor L, and a drain of the transistor S7 is coupled to a node of the capacitor C1 and the transistors S1, S2. The drain of the transistor S3 is coupled to the second terminal of the capacitor C1, and the source of the transistor S4 is coupled to the node of the capacitor C1 and the transistors S1, S2. The diode D2 and the transistor S4 may be coupled in series to interrupt a current path formed by the body diode of the transistor S4, as shown in FIG. 16. In addition, a cathode and an anode of the diode D4 are respectively coupled to the second terminal of the inductor L and the ground terminal, and a cathode and an anode of the diode D5 are respectively coupled to the first terminal of the inductor L and the ground terminal. When the inductor L has the remaining current by the resonance, the respective diodes D4 and D5 free-wheel this current and recover the remaining energy to the power source Vs/2.

An operation of the sustain discharge circuit 410C shown in FIG. 16 will now be described with reference to FIG. 17 and FIG. 18A to FIG. 18D.

FIG. 17 shows a diagram representing signal timing of the sustain discharge circuit 410C according to the sixth exemplary embodiment of the present invention, and FIG. 18A to FIG. 18D respectively show operations of the sustain discharge circuit 410C shown in FIG. 16 according to the signal timings shown in FIG. 17.

Firstly, as shown in FIG. 17 and FIG. 18A, since the transistors S2, S4 are turned on at a first mode M1″, the 0V is applied to the X electrode through a path from the X electrode, through the transistor S4, the diode D2, and the transistor S2, to the ground terminal. In addition, as shown in FIG. 18A the Vs/2 voltage is charged in the capacitor C1 through a path of the power source Vs/2, the diode D1, the capacitor C1, the transistor S2, and the ground terminal. In this case, since the voltage at the drains of the transistors S2, S4 is 0V and the voltage at the drains of the transistors S1 and S3 is the Vs/2 voltage, the voltage that is lower than the Vs/2 voltage is applied between the drains and the sources of the turn-off transistors S1, S3, S7, S8. That is, the transistors S1, S3, S7, S8 having a Vs/2 voltage may be used.

At a second mode M2″, since the transistors S2 and S4 are turned off and the transistors S1 and S7 are turned on, the resonance is generated through a path of the power source providing the Vs/2 voltage, the transistor S1, the transistor S7, the inductor L, the body diode of the transistor S8, and the panel capacitor (Cp), as shown in FIG. 18B. Accordingly, the energy stored in the power source Vs/2 is provided to the X electrode through the inductor L, and the voltage Vx at the X electrode is increased from 0V to the Vs voltage. Since the resonance path is formed through a body diode of the transistor S8, a remaining resonance (i.e., a resonance during a second half of the resonance period) is suppressed by a reverse direction current after the resonance during a first half of the resonance period is finished. Accordingly, there is no need to provide an additional diode for guaranteeing the resonance having a half of the resonance period.

At a third mode M3″, since the transistor S3 is turned on and the transistor S7 is turned off while the transistor S1 is turned on, the Vs voltage is applied to the X electrode through the power source Vs/2, the transistor S1, the capacitor C1, and the transistor S3, as shown in FIG. 18C. In addition, at the second mode M2″, when the current I_{L} remains in the inductor L after increasing the voltage at the X electrode to the Vs voltage, the remaining current I_{L} is free-wheeled through the ground terminal, the diode D4, the inductor L, the body diode of the transistor S8, the body diode of the transistor S3, the capacitor C1, the body diode of the transistor S1, and the power source Vs/2. That is, the remaining energy in the inductor L is recovered to the capacitor C1 and the power source Vs/2. In this case, since the voltage at the drain of the transistor S2 is the Vs/2 voltage and the voltage at the drain of the transistor S4 is the Vs voltage, the Vs/2 voltage is applied between the drains and the sources of the turn-off transistors S2, S4, S7, S8. That is, the transistors S2, S4, S7, S8 having the Vs/2 voltage may be used.

At a fourth mode M4″, since the transistor S3 is turned off and the transistor S8 is turned on while the transistor S1 is turned on, a resonance is generated through a path of the panel capacitor Cp, the transistor S8, the inductor L, the body diode of the transistor S7, the body diode of the transistor S1, and the power source Vs/2. By this resonance, the energy stored in the panel capacitor Cp is recovered to the power source providing the Vs/2 voltage through the inductor L, and the voltage Vx at the X electrode is decreased from the Vs voltage to the 0V. In this case, since the power source supplies the Vs/2 voltage, the voltage Vx at the X electrode may be decreased to the 0V during a half of the resonance period. While it has been described that the transistor S1 is turned on at the fourth mode M4″, the transistor S1 may be turned off at the fourth mode M4″ since the resonance path is formed by the body diode of the transistor S1. In addition, the resonance path is formed by the body diode of the transistor S7, and the resonance during the second half of the resonance period is suppressed by the reverse direction current after the resonance during the first half of the resonance period is finished. Accordingly, there is no need to provide an additional diode for guaranteeing the resonance having a half of the resonance period.

In addition, the first mode M1″ is repeated after the fourth mode M4″ is finished. In this case, when the current I_{L} remains in the inductor L after decreasing the voltage at the X electrode to the 0V at the fourth mode M4″, the remaining current I_{L} is free-wheeled through the ground terminal, the diode D5, the inductor L, the body diode of the transistor S7, the body diode of the transistor S1, and the power source Vs/2 (not shown). That is, when the current remains in the inductor L, the remaining energy is recovered to the power source Vs/2.

As described, according to the sixth exemplary embodiment of the present invention, the Vs voltage and the 0V voltage are alternately applied to the X electrode since the first mode M1″ to the fourth mode M4″ are repeatedly performed a number of times corresponding to a weight value of a corresponding subfield during the sustain period.

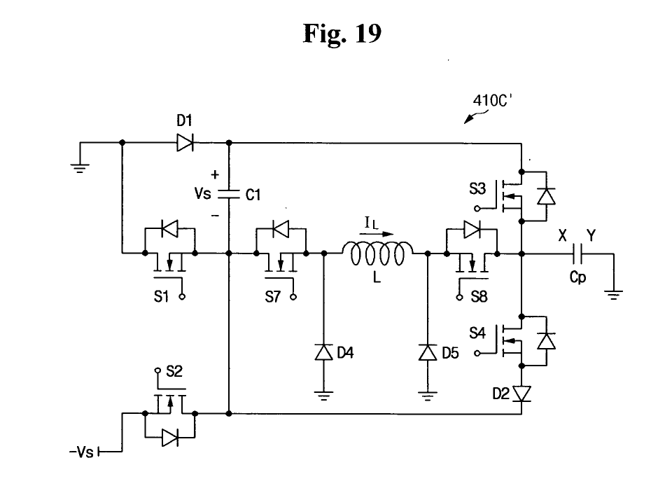

In the sixth exemplary embodiment of the present invention, it has been described that the sustain pulse alternately has the high-level voltage and the low-level voltage and the sustain pulses of reverse phases are respectively applied to the X electrode and the Y electrode. However, differing from FIG. 14, the sustain pulse may be applied to one of the X electrode and the Y electrode, which will be described with reference to FIG. 19.

FIG. 19 shows a schematic circuit diagram of a sustain discharge circuit 410C′ according to a seventh exemplary embodiment of the present invention.

Referring to FIG. 19, the sustain discharge circuit 410C′ according to the seventh exemplary embodiment of the present invention is the same as that of the sixth exemplary embodiment of the present invention, except for the voltage supplied from the power source and the voltage charged in the capacitor C1. In further detail, the drain of the transistor S1 is coupled to the ground terminal, and the source of the transistor S2 is coupled to a power source −Vs for supplying the −Vs voltage. Accordingly, the −Vs voltage and the 0V may be selectively applied to the first terminal of the capacitor C1 according to the operation of the transistors S1, S2. When the transistor S2 is turned on, the capacitor C1 may be charged with the Vs voltage by the diode D1.

Then, the Vs voltage is applied to the X electrode through the ground terminal, the transistor S1, the capacitor C1, and the transistor S3 at the third mode M3″ shown in FIG. 17, and the −Vs voltage may be applied to the X electrode through the transistor S4, the diode D2, the transistor S2, and the power source −Vs at the first mode M1″. In addition, the voltage that is lower than the Vs voltage corresponding to the difference between the high-level voltage (Vs) and the low-level voltage (−Vs) is applied between the drain and the source of the turn-off transistor in the seventh exemplary embodiment of the present invention. Accordingly, the sustain discharge circuit 410C′ according to the seventh exemplary embodiment of the present invention alternately applies the Vs voltage and the −Vs voltage to the X electrode, and may use the transistor having the low voltage.

While it has been described that the sustain discharge circuit 410C′ is coupled to the X electrode and the 0V is applied to the Y electrode in FIG. 19, the sustain discharge circuit may be coupled to the Y electrode, and the 0V may be applied to the X electrode.

In addition, when the source of the transistor S2 is coupled to the power source for supplying the −Vs voltage in the circuit shown in FIG. 19, the sustain pulse alternately having the Vs/2 voltage and the −Vs/2 voltage may be applied to the X electrode. In this case, the sustain pulse having a reverse phase of the sustain pulse applied to the X electrode may be applied to the Y electrode.

According to the exemplary embodiments of the present invention, a cost of the sustain discharge circuit may be reduced since a transistor having a low voltage may be used.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and equivalents thereof.

What is claimed is:

1. A plasma display device comprising:
a plurality of first electrodes;
a first transistor having a first transistor first terminal electrically coupled to a first power source for supplying a first voltage;
a second transistor having a second transistor first terminal electrically coupled to a first transistor second terminal and having a second transistor second terminal electrically coupled to a second power source for supplying a second voltage;
a capacitor charged with a third voltage and having a capacitor first terminal electrically coupled to a node of the first transistor and the second transistor, and a capacitor second terminal;
a charging path electrically coupled between the first power source and the capacitor second terminal;
a third transistor electrically coupled between the capacitor second terminal and the plurality of first electrodes; and
a fourth transistor electrically coupled between the plurality of first electrodes and the capacitor first terminal.

2. The plasma display device of claim 1, wherein the charging path comprises a diode having a diode anode electrically coupled to the first power source and a diode cathode electrically coupled to the capacitor second terminal.

3. The plasma display device of claim 1, wherein the capacitor is charged with the third voltage when the second transistor is turned on, and the third voltage corresponds to a difference between the first voltage and the second voltage.

4. The plasma display device of claim 1, further comprising a controller for setting the second transistor and the fourth transistor to be turned on during a first period, setting the third transistor to be turned on during a second period, setting the first transistor and the third transistor to be turned on during a third period, and setting the third transistor to be turned on during a fourth period.

5. The plasma display device of claim 1, further comprising:
an inductor having an inductor first terminal electrically coupled to the plurality of first electrodes, and an inductor second terminal;
a fifth transistor electrically coupled between the capacitor second terminal and the inductor second terminal; and
a sixth transistor electrically coupled between the inductor second terminal and the capacitor first terminal.

6. The plasma display device of claim 5, further comprising a first diode coupled to the fourth transistor in series and formed in an opposite direction of a body diode of the fourth transistor.

7. The plasma display device of claim 6, further comprising a second diode having a cathode electrically coupled to the plurality of first electrodes and an anode electrically coupled to the second power source.

8. The plasma display device of claim 5, further comprising a controller for setting the second transistor and the fourth transistor to be turned on during a first period, setting the first transistor and the fifth transistor to be turned on during a second period, setting the first transistor and the third transistor to be turned on during a third period, and setting the first transistor and the sixth transistor to be turned on during a fourth period.

9. The plasma display device of claim 5, further comprising a controller for setting the second transistor and the fourth transistor to be turned on during a first period, setting the first transistor and the sixth transistor to be turned on during a second period, setting the second transistor and the third transistor to be turned on during a third period, setting the first transistor and the fifth transistor to be turned on during a fourth period, setting the first transistor and the third transistor to be turned on during a fifth period, and setting the first transistor and the sixth transistor to be turned on during a sixth period.

10. The plasma display device of claim 1, further comprising:
a fifth transistor having a fifth transistor first terminal electrically coupled to the plurality of first electrodes, and a fifth transistor second terminal;
an inductor having an inductor first terminal electrically coupled to the fifth transistor second terminal, and an inductor second terminal; and
a sixth transistor electrically coupled between the capacitor first terminal and a inductor second terminal.

11. The plasma display device of claim 10, further comprising a first diode coupled to the fourth transistor in series, and formed in an opposite direction of a body diode of the fourth transistor.

12. The plasma display device of claim 11, further comprising:
a second diode having a second diode cathode electrically coupled to a node of the inductor and the sixth transistor and a second diode anode electrically coupled to the second power source; and
a third diode having a third diode cathode electrically coupled to a node of the inductor and the fifth transistor and a third diode anode electrically coupled to the second power source.

13. The plasma display device of claim 10, further comprising a controller for setting the second transistor and the fourth transistor to be turned on during a first period, setting the first transistor and the sixth transistor to be turned on during a second period, setting the first transistor and the third transistor to be turned on during a third period, and setting the first transistor and the fifth transistor to be turned on during a fourth period.

14. The plasma display device of claim 1, wherein the second voltage is a ground voltage and the first voltage is a positive voltage.

15. The plasma display device of claim 1, wherein the first voltage is a ground voltage and the second voltage is a negative voltage.

16. A driving method of a plasma display device having a first electrode and a second electrode, the driving method comprising:
applying a first voltage to the first electrode through a first power source for supplying the first voltage;
applying a third voltage corresponding to a sum of the first voltage and a second voltage to the first electrode through the first power source and a capacitor being charged with the second voltage;
applying the first voltage to the first electrode through the first power source; and
applying a fourth voltage that is lower than the first voltage to the first electrode.

17. The driving method of claim 16, wherein the applying of the fourth voltage to the first electrode further comprises charging the capacitor with the second voltage through the first power source.

18. The driving method of claim 16, wherein the applying of the third voltage to the first electrode comprises applying the fourth voltage to the second electrode, and the applying of the fourth voltage to the first electrode comprises applying the third voltage to the second electrode.

19. The driving method of claim 18, wherein the first voltage is the same as the second voltage, and the fourth voltage is a ground voltage.

20. The driving method of claim 16, wherein a difference between the first voltage and the fourth voltage is the same as the third voltage.

21. A driving method of a plasma display device comprising a first electrode and a second electrode, the driving method comprising:
supplying energy stored in a first power source for supplying a first voltage and a capacitor being charged with a second voltage to the first electrode through an inductor coupled to the first electrode, and increasing a voltage at the first electrode;
applying a third voltage corresponding to a sum of the first voltage and the second voltage to the first electrode through the first power source and the capacitor;
recovering energy stored in the first electrode to the first power source through the inductor, and decreasing the voltage at the first electrode; and
applying a fourth voltage that is lower than the first voltage to the first electrode.

22. The driving method of claim 21, wherein the applying of the fourth voltage to the first electrode comprises charging the capacitor with the second voltage through the first power source.

23. The driving method of claim 21, wherein the applying of the third voltage to the first electrode comprises recovering energy remaining in the inductor to the capacitor.

24. The driving method of claim 21, wherein the applying of the third voltage to the first electrode comprises applying the fourth voltage to the second electrode, and the applying of the fourth voltage to the first electrode comprises applying the third voltage to the second electrode.

25. The driving method of claim 24, wherein the first voltage is the same as the second voltage, and the fourth voltage is a ground voltage.

26. A driving method of a plasma display device having a first electrode and a second electrode, the driving method comprising:
supplying energy stored in a first power source for supplying a first voltage to the first electrode through an inductor electrically coupled to the first electrode, and increasing a voltage at the first electrode;
applying a third voltage corresponding to a sum of the first voltage and a second voltage to the first electrode through the first power source and a capacitor being charged with the second voltage;
recovering energy stored in the first electrode to the power source through the inductor, and decreasing the voltage at the first electrode; and
applying a fourth voltage that is lower than the first voltage to the first electrode.

27. The driving method of claim 26, wherein the applying of the fourth voltage to the first electrode comprises charging the capacitor with the second voltage through the first power source.

28. The driving method of claim 26, wherein the applying of the third voltage to the first electrode comprises recovering energy remaining in the inductor to the capacitor.

29. The driving method of claim 26, wherein the applying of the third voltage to the first electrode comprises applying the fourth voltage to the second electrode, and the applying of the fourth voltage to the first electrode comprises applying the third voltage to the second electrode.

30. The driving method of claim 29, wherein the first voltage is the same as the second voltage, and the fourth voltage is a ground voltage.
